(19) United States
(12) Patent Application Publication
(10) Pub. No.: US 2017/0063966 A1
(43) Pub. Date: Mar. 2, 2017

(54) REAL TIME DATA STREAMING FROM A MAINFRAME COMPUTER TO OFF PLATFORM DESTINATIONS

(71) Applicant: CA, Inc., New York, NY (US)

(72) Inventors: Charles J. Kalish, Pittsburgh, PA (US); Lubomil Slivka, Prague (CZ); Gregory Neil MacKinnon, Stow, MA (US)

(73) Assignee: CA, Inc., New York, NY (US)

(21) Appl. No.: 14/840,809

(22) Filed: Aug. 31, 2015

(51) Int. Cl. H04L 29/08; G06F 9/455; H04L 12/861

(52) U.S. Cl. CPC H04L 67/10; H04L 49/9005; G06F 9/45516

(57) ABSTRACT

A method and computer product which re-directs sequential data to an off-platform system without modification of the source of the sequential data. An operating system on a first processing system is caused to create a privileged subsystem in the operating system. The privileged subsystem acquires sequential data output by a data producing application directed to a named dataset. An instruction specifies that the sequential data from the data producing application to the named dataset be processed by the privileged subsystem. A data forwarder is created on the first processing system. The data forwarder establishes communication with an external processing system and acquires the sequential data from the privileged subsystem. The data forwarder transmits the sequential data to the external processing system based on the instruction, and the instruction defines the external processing system as a destination for the sequential data.

### BACKGROUND

Many applications and programs on computing systems produce data streams as sequential files that are reside on disk, tape or spool files. In many cases, it may be desirable to transfer such data streams to other computing systems. One example is where data streams are created in multi-workload mainframe systems, where each unit of work is associated with a cost, and movement of data to off-mainframe systems for additional processing is more cost effective than performing such additional processing on the mainframe system. While mechanisms exist to move data from, for example, a mainframe system to off platform targets, these methods are either batch oriented or require programming changes on the part of the data producer (the application) to enable the transport of data off platform.

### BRIEF SUMMARY

According to one aspect of the present disclosure, technology is described which provides a method of re-directing sequential data to an off-platform system. The method includes causing an operating system on a first processing system to create a privileged subsystem in the operating system. The privileged subsystem acquires sequential data output by a data producing application which is directed by the data producing application to a named dataset via the operating system responsive to an instruction to the operating system. The instruction specifies that the sequential data from the data producing application to the named dataset be processed by the privileged subsystem. The method further comprises causing the first processing system to create a data forwarder. The data forwarder establishes communication with an external processing system and acquires the sequential data from the privileged subsystem. The data forwarder transmits the sequential data to the external processing system based on the instruction, and the instruction defines the external processing system as a destination for the sequential data.

In another aspect, the technology provides a computer program product. The product comprises a computer readable storage medium having computer readable program code embodied therewith. The computer readable program code is configured to create a privileged subsystem in a processing system having other subsystems accessible to applications on the processing system. The privileged subsystem is configured to receive sequential data output from an application which is directed by the application to a named dataset addressed by the application and stored on a memory device in the processing system. In addition, computer readable program code is configured to create a data forwarder. The data forwarder is adapted to communicate with an external processing system, and to transmit the sequential data acquired by the privileged subsystem to the external processing system. The computer readable program code configured to create the privileged subsystem and the data forwarder responds to an instruction to an operating system which specifies output requests by the application to the named dataset be processed by the privileged subsystem. The instruction further specifies the external processing system as a destination for the sequential data to the data forwarder.

In another embodiment, a computing apparatus includes a processor and a memory, and the processor configured to access the memory to execute instructions. The apparatus includes a storage device. The storage device includes code stored in the storage device configured to create a pseudo-device recognized by an operating system. The pseudo-device is addressable by the operating system to receive sequential data from an application which is configured to write the sequential data to a named dataset addressed in the application. The operating system directs the sequential data addressed to the named dataset by the application to the pseudo-device. The storage device includes code stored in the storage device configured to create a data forwarder adapted to communicate with an external processing system. The data forwarder is adapted to transmit the sequential data acquired by the pseudo device to the external processing system. The pseudo device and the data forwarder respond to an instruction to the operating system specifying output requests by the application to the named dataset be directed to the pseudo device and specifying the external processing system as a destination for the sequential data to the data forwarder.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 illustrates an exemplary computing environment.

FIG. 2 illustrates an exemplary computing environment in which the present technology may be implemented.

FIG. 3 is a flowchart illustrating a method in accordance with the present technology.

FIG. 4 is a flowchart illustrating one method of performing step 340 in FIG. 3 for forwarding named data to external devices.

FIG. 5a is a block diagram depicting one type of message from a forwarder in accordance with the present technology.

FIG. 5b is a block diagram depicting a second message from a forwarder in accordance with the present technology.

FIG. 6 is a block diagram depicting functional elements of a forwarder in accordance with the present technology.

FIG. 7 is an exemplary processing device suitable for use as any of the computing devices illustrated herein.

### DETAILED DESCRIPTION

Technology is provided which enables re-direction of a sequential data stream from an application on a processing system to off-platform (or external) system destinations without modification of the application. The technology is particularly useful in mainframe computing systems where multiple applications output sequential data and wherein processing of such data is more cost-effectively performed on another processing device. The technology utilizes a privileged subsystem and an instruction to the operating system directing the data output of the application to a named data set to be redirected to the subsystem. In instruction to the subsystem may specify the destination for the output sequential data. A data forwarder negotiates with a data receiver on the off-platform system and transmits the data to the data receiver on the off-platform system. The instruction to the operating system may take the form of a job control language (JCL) statement or dynamic allocation. No programming effort is required on the part of the application developer in order to redirect sequential data to off-platform systems.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

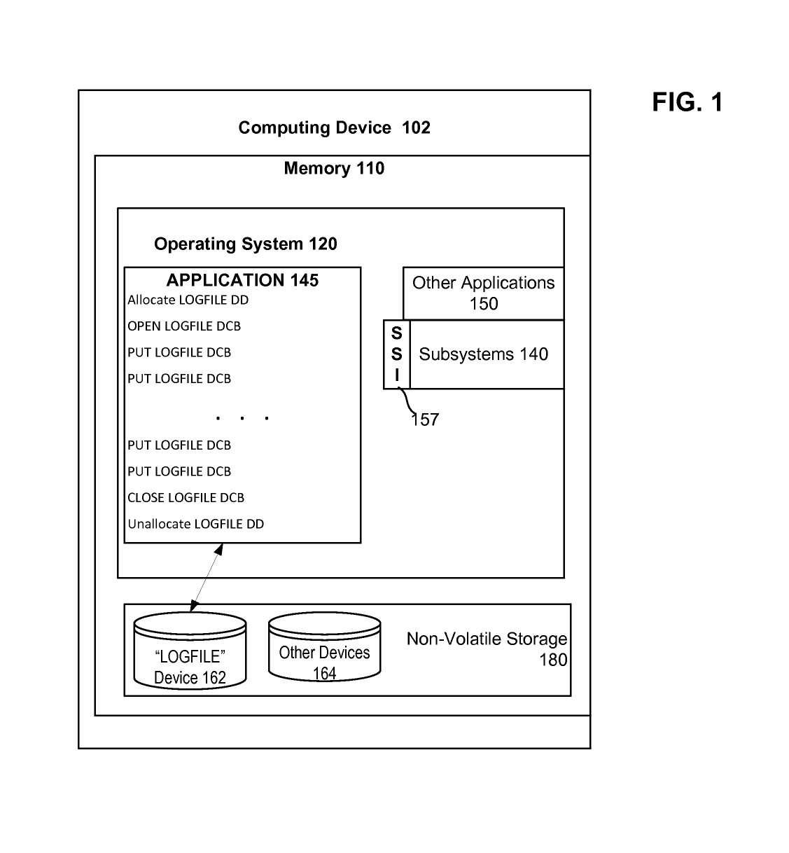

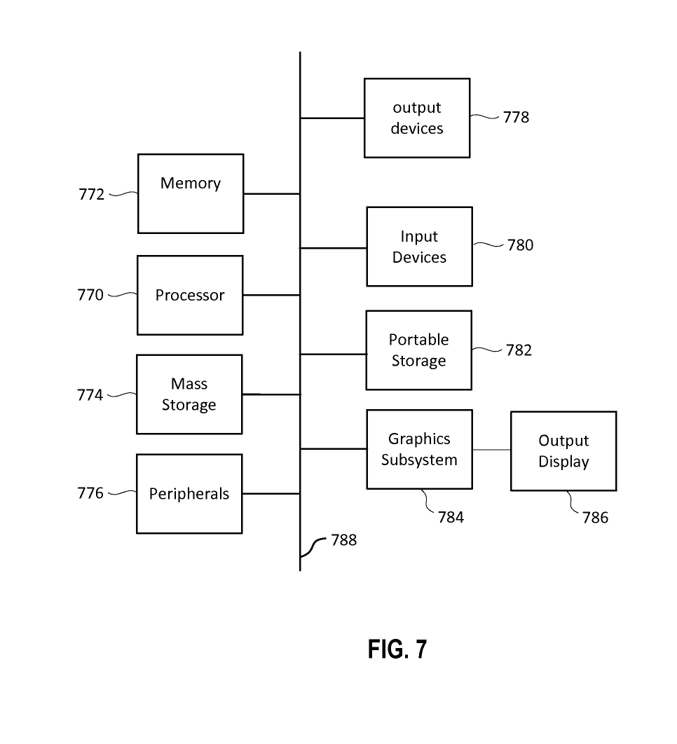

FIG. 1 illustrates a first computing environment suitable for implementing the technology discussed herein. The computing environment includes a processing device 102 which includes a memory 110 in which an operating system 120 may be provided. Processing device 102 may comprise a processing device such as that illustrated in FIG. 7 below. In one embodiment, the computing environment is a mainframe computing system in which one or more applications 145, 150 are operating in memory 110 and which interact with elements of the computing environment through the operating system 120. The operating system 120 may be any operating system supporting a wide range of interactive services and data access methods, and meeting the criteria discussed herein. The operating system may provide support for various programming languages and virtual machines, as well as UNIX application programming interfaces and UNIX system services. The operating system may include a workload management facility to allow management of concurrent applications running in separate, protected addresses spaces. In addition, the operating system may provide support for one or more developer created, privileged subsystems to act as a pseudo-device recognized by the operating system, may be utilized. The technology is particularly useful with operating systems for mainframe computers such as the z/OS operating system available from International Business Machines, Armonk, N.Y.

The operating system 120 may include a capability of providing any number of subsystems 140. Each subsystem is a service that performs one to many functions. Generally the provider of an operating system capable of implementing sub-systems will include subsystems with the operating system distribution. Third party authors may also be allowed to create and provide subsystems for specialized tasks.

Subsystems 140 may be accessed via a sub-system interface (SSI) 157. The SSI is the interface used by applications to request services of, or to pass information to, subsystems 140. An operating system installation provider, a system operator, or third parties may use the SSI to make and monitor subsystem requests. The SSI generally acts as a mechanism for transferring control and data between a requestor and the subsystem. It is known to extend the function of an operating system by writing and invoking one's own subsystem. To invoke a subsystem through the SSI, one instructs the SSI as to the function one is requesting and the subsystem with which one wishes to communicate.

When a non-standard subsystem is provided, an author or provider of the subsystem provides routines to support requested subsystem functions. The subsystem functions obtain various controls from the SSI. Subsystem routines may actually perform the function or may pass control to other routines that the author of the subsystem provides. The subsystem author may provide a subsystem address space in the operating system (if needed by the subsystem), define the subsystem to the operating system to allow the operating system to know the subsystem exists, and provide any control blocks or resources that the subsystem requires for its own operation.

The processing device 102 may include non-volatile storage 180. Illustrated in non-volatile storage 180 are two system-recognized storage devices 162 and other devices 164. Many operating system applications, including, in this example, application 145, produce data streams as sequential files that are reside on disk, tape or spool file.

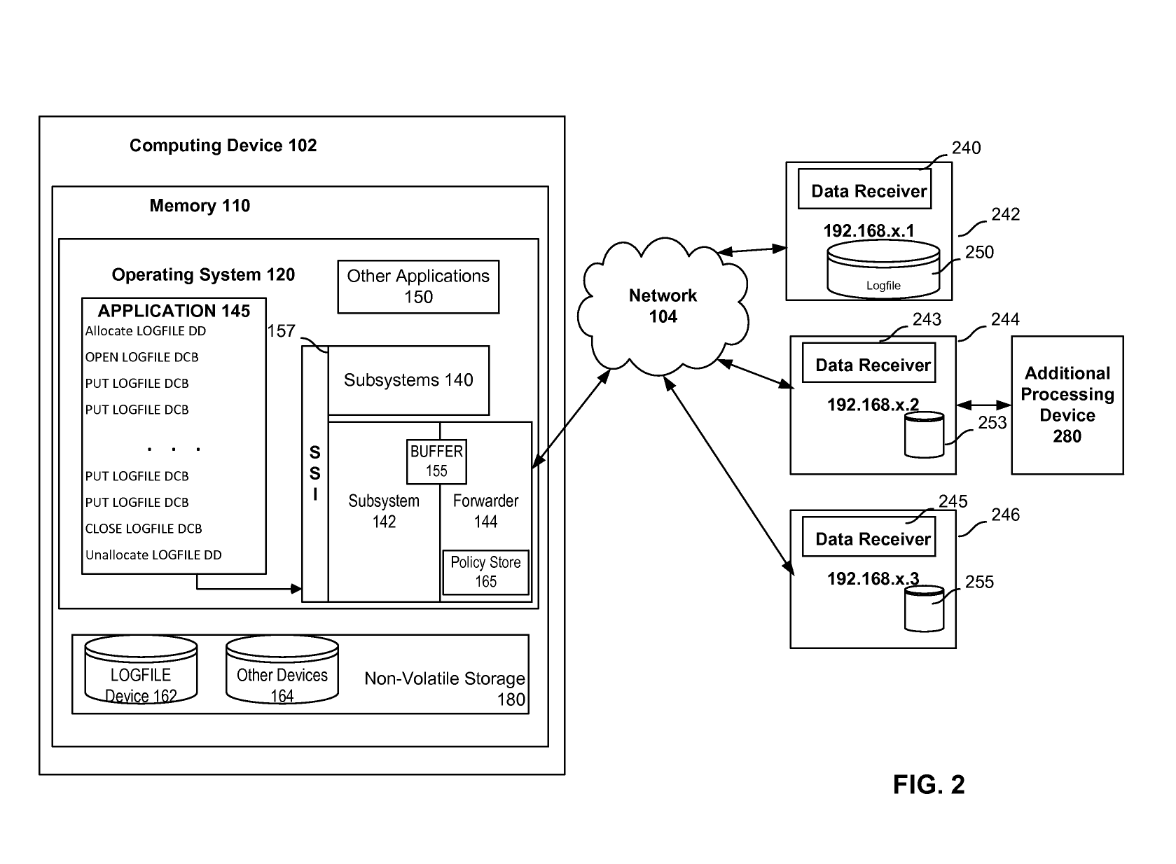

Application 145 may be provided by the creator of the operating system 120 or any party capable of developing applications suitable for execution on the processing device 102 and within the operating system 120. Application 145 comprises a data producing application and may include computer code operable to provide sequential streaming data to a system storage device in non-volatile storage 180. In the example of FIGS. 1 and 2, application 145 outputs a data stream of sequential data to device 162, defined by the application 145 and recognized by the operating system 120. Illustrated in application 145 are a series of instructions to output streaming data to device 162 denoted as LOGFILE. The name LOGFILE is arbitrary but is a name specified by application 145. As illustrated in application 145, instructions include: an allocate command—allocating the data set (device 162) in the non-volatile storage 180; an open command—initializing one or more data control blocks (DCBs) so that their associated data sets can be processed; a series of put commands to write (load) records to an empty data set, and insert or update records into an existing data set (LOGFILE) to write data to device 162; a close command—used to end processing of a data set and release it from a DCB; and an unallocate command which unallocates the specified device that was created and returned when using the allocate command.

In the context of FIGS. 1 and 2, the instructions illustrated in application 145 are exemplary only. In the example shown in FIG. 1, the author of the application 145 has specified an output (LOGFILE) for sequential streaming data. Normally, in order to specify a new output for the data directed to the LOGFILE output, the instructions illustrated in application 145 would be changed by the author of application 145. Alternatively, one can run a batched acquisition process, such as batched FTP commands to an operating system FTP process, may provide access to datasets in the non-volatile storage 180 on the computing environment.

The present technology allows for re-direction of the output of an application such as application 145 to an external device without changing the code of an existing application, and without the use of batched processing techniques. Hence, the streaming data output of an application may be provided in real time to platforms external to the computing environment.

FIG. 2 illustrates a second computing environment suitable for implementing the present technology. Elements illustrated in FIG. 2 which have like elements illustrated in FIG. 1 are denoted with like reference numbers. In FIG. 2, the processing device 102, memory 110, operating system 120, application 145 and non-volatile storage 180 are equivalent to those illustrated in FIG. 1. Notably, application 145 remains unchanged in FIG. 2. As discussed below, the technology provides dynamic redirection of sequential data without modification of application 145.

Processing device 102 may be coupled to a network 104. Network 104 may comprise a public network, a private network, or a series of public and private networks such as the Internet. Processing device 102 may include a network interface (not shown) allowing connection to and communication through network 104 to other off-platform processing devices 242, 244, 246. Each off-platform processing device 242, 244, 246 may include hardware elements such as those illustrated in FIG. 7. In addition, each processing device 242, 244, 246 may include a data receiver 240, 243 and 245, and a storage device 250, 253, 255. Each of the processing devices 242, 244, and 246 comprises an external or “off-platform” target for data generated by one or more application programs, such as application 145, in accordance with the technology. The data receiver may be an application executing in a memory of each of processing devices 242, 244, and 246 which is configured to receive a data stream of sequential data output from processing device 102. Each of the storage devices 250, 253 and 255 may be a non-volatile storage device utilized by the data receiver to store the data stream of sequential data. One or more additional processing devices 280 may communicate with processing device 244, although any of the processing devices 242, 244, 246 may likewise communicate with an additional processing device such as device 280. Each of the processing devices 242, 244, 246 may be addressable by a network address (illustrated as part of a private subnet 192.168.x.1 . . . 3/255), though it should be understood that the illustrated addresses are shown as exemplary only. It should be understood that the processing devices 242, 244, 246 may be addressable by any number of network addressing schemes, need not be on the same subnet or even the same network, and may include additional elements not illustrated in FIG. 2.

Further illustrated in FIG. 2 is a privileged subsystem 142, data forwarder 144 and buffer 155. In one embodiment, a policy store 165 is included with the data forwarder 144. In another embodiment, no policy store need be utilized. Privileged subsystem 142 is a subsystem created by code adapted instruct a processor in the computing device to create the subsystem in the operating system with the subsystem having root level access to at least some of the computing system resources via the operating system. Privileged subsystem 142 is so privileged in order to allow the privileged subsystem 142 to access system level devices and perform the techniques described herein. As is well known, an operating system is capable of recognizing computing system devices and resources, and accessing such devices logically. The operating system may permit or restrict access to the devices through a specified set of permissions for a device. In the context of this technology, the privileged subsystem may be considered to act as a pseudo-device, as it accesses write (put) commands from an application to an operating system recognized device 162 (i.e. LOGFILE in this example).

Privileged subsystem 142, data forwarder 144 and buffer 155 may be configured to operate in a reserved address space within memory 110. Buffer 155 itself comprises a system level address space, and provides a location to stage and manage data received from applications (such as application 145) through the privileged subsystem 142.

Data forwarder 144 negotiates and establishes connections with any number off-platform systems, such as processing devices 242, 244, 246. The processing devices are illustrated as being identified by IP address and port number, but as noted herein, any number of addressing schemes may be utilized. The data forwarder 144 implements a communication protocol with a data receiver on a destination system to synchronize communication, to identify data types being forwarded and to control data flow between the devices. In one implementation, the communication protocol may comprise TCP/IP, though other protocols may be utilized. Forwarder may comprise comprises a Unix System Services (USS) based communication layer available on nay number of different operating systems.

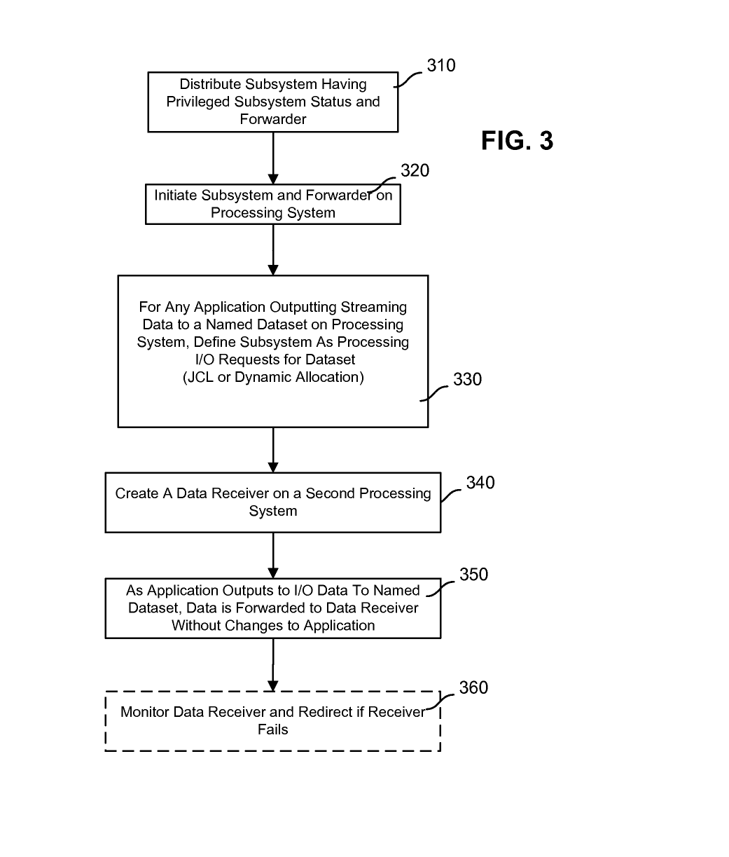

As discussed below with respect to FIG. 3, as the application 145 produces data and writes it to device 162, the access method provided by the privileged subsystem 142 accepts the data and buffers using buffer 155 for the data forwarder 144. Although only one data producing application (application 145) is shown, there may be multiple data producing applications.) Data forwarder 144 transmits data from the buffer 155 to a peer data receiver on the destination system utilizing, for example, TCP/IP protocol.

In one embodiment, data forwarder 144 accepts instructions which direct the data to one or more specific data receivers through an instruction provided to the SSI. In one alternative, a specific address of a data receiver may be specified in the form of an IP address. In another alternative, the instruction may specify metadata utilized to identify a policy type, and the forwarder may utilize user-defined policies to select an appropriate data receiver. For example, the technology allows for processing of the data output by application 145 by the off-platform devices 242, 244, 246. The instruction may specify metadata including a data type which is used to select a data receiver capable of processing the data output by application 145 from a defined policy. The policy may specify include a list of off-platform devices on which processing may be performed, with the forwarder selecting among appropriate defined off-platform devices which are capable of providing the data processing specified in the policy. In this second embodiment, the forwarder, and specifically the policy definitions in the policy store 165, is configured with a number of off-platform devices 242, 244, 246 such that when new data source is configured through the SSI, the forwarder negotiates with the off-platform devices 242, 244, 246 to determine which remote system to connect to and send data.

As noted above, in one embodiment, privileged subsystem 142 acts as a pseudo device, recognized by the operating system through a subsystem allocable data set. The subsystem may be allocated as a dataset using a job control language (JCL) statement or through dynamic allocation text units. Each of the JCL statement and the dynamic allocation may comprise an instruction to the operating system which specifies that the sequential data from the data producing application to the named dataset be processed by the privileged subsystem.

Specifications provided on the pseudo device at allocation time are used to determine the target off platform destination, the classification type of the data stream, and an identifier associated with the data stream. In a first example, an exemplary JCL statement (for the system shown in FIG. 2) takes the form:

//LOGFILE DD DSN=MY.LOG.DATA, DISP=SHR,
SUBSYS=(SUBA,’DEST=192.168.x.001:9898’,
‘TYPE=LOGDATA’,’ID=PRODUCTA’)

In this example, the DD statement defines the dataset name LOGFILE (or the output of any application) as input and output resources for a job. DISP=SHR describes the dataset as already created and read in the next job step. The SUBSYS parameter defines the name of the privileged subsystem (in this example SUBA) and the specific destination (in this example 192.168.x.001, port 9898). The statement also identifies a data type—“logdata” and an identifier “producta.” The type and ID define additional metadata for the external system which may comprise instructions relative to any additional processing to be performed by the off-platform system. The destination information is passed to the SUBA subsystem and forwarder 144. When the application opens the LOGFILE access method control block, the subsystem completes the conversion to SUBA processing.

A second exemplary JCL statement utilized in conjunction with another embodiment wherein the forwarder determines off-platform device destinations may take the form:

//LOGFILE DD DSN=MY.LOG.DATA, DISP=SHR,

SUBSYS=(SUBA, ‘TYPE=LOGDATA’,’ID=PRODUCTA’)

In the second statement, the specific destination is omitted and the TYPE and/or ID may be utilized to determine which of off-platform devices 242, 244, 246 to utilize.

In an alternative embodiment, dynamic allocation is used. Dynamic allocation requests resources by, in one example, enabling a dynamic allocation service and providing instructions to an operating system provided dynamic allocation instruction set for a dynamic application operating system service. The service allocates and deallocates input/output resources while an application is running. Dynamic allocation tailors device allocations based on input to the application service.

As such, the technology supports the ability to provide parameters that may be used as specifications by the privileged component. The SSI provides the capability for a privileged system component—the privileged subsystem 144—to gain control points out of operating system processes.

FIG. 3 is a general method implementing the present technology. In FIG. 3, the steps 310 may be performed by a system administrator or subsystem provider, while step 340 may be a processor implemented process.

At step 310, a subsystem having a privileged status and forwarder are distributed by a subsystem provider or administrator. The subsystem and forwarder may be distributed by distributing code adapted to cause a computing environment with a suitable operating system to create a privileged subsystem and forwarder in the operating system as described herein. As noted above, the subsystem may create a reserved system memory address space to implement a buffer and space to perform the functions of the subsystem and forwarder discussed herein. The subsystem may distributed to any of a number of computer processing devices. The distribution at step 310 may cause an operating system to create a privileged subsystem and a data forwarder when the operating system later executes the code.

At 320, the subsystem and the forwarder are initiated on a processing system. The subsystem may be initiated by an operator of the computing environment or programmatically as part of an installation. The initiation or execution of code adapted to create the subsystem and forwarder may cause the processing system to create the privileged subsystem and the data forwarder in the operating system.

At 330, for any application outputting streaming data to a named data set on a processing system, the subsystem is defined as the processing device for input out requests to the data set. As noted above, in one implementation, the definition is created by a JCL statement or as a dynamic allocation. The definition of the subsystem as the output for the named dataset of the application from the computing environment may be provided by any party having sufficient system privileges to provide the instructions needed to submit the requisite instructions to the computing environment. The definition of the subsystem may comprise an instruction to the operating system identifying a named data set output from the application to be processed by the privileged subsystem. The definition may further specify a secondary processing device data receiver destination address, or the destination for the data receiver may be determined programmatically based on one or more policies listing suitable processing devices capable of processing the data based on a defined type and/or data identifier.

At 340, a data receiver is created on a secondary processing system. The data receiver may be created by distributing code adapted to cause a secondary computing environment with a suitable operating system to create a data receiver as described herein as described herein. The data receiver may also be created by causing the secondary computing environment to execute code adapted to create the data receiver. It should be recognized that in one embodiment, step 340 may occur at any point in the flowchart of FIG. 3 prior to step 350, including prior to the distribution of the privileged subsystem in step 310.

At 350, as the application 145 outputs data to the named dataset specified in the application, the sequential data is forwarded to the specified data receiver. Forwarding by the subsystem and forwarder comprise a computer implemented method in a processing device which receives sequential data output from the application which is directed by the application to the named dataset addressed by the application and stored on a memory device in the processing system communicating with the secondary, external processing system, and transmitting the sequential data acquired by the privileged subsystem to the secondary, external processing system.

Optionally, at 360, the data receiver may be monitored to determine whether any issues are created with the data receiver and if so, the data may be redirected to a different data receiver capable of processing the data. If, for example, a data receiver fails, the forwarder may re-direct the data to a different receiver. At step 360, the forwarder may monitor a control connection established with the data receiver to detect whether an issue with the data receiver exists. An issue may arise, for example, if communication with the receiver is interrupted or any designated processing on the receiver is interrupted. In such case, the forwarder may utilize a decision process (in one example, based on a policy identified for data from the application data source) to determine another data receiver suitable for receiving the data from the data source.

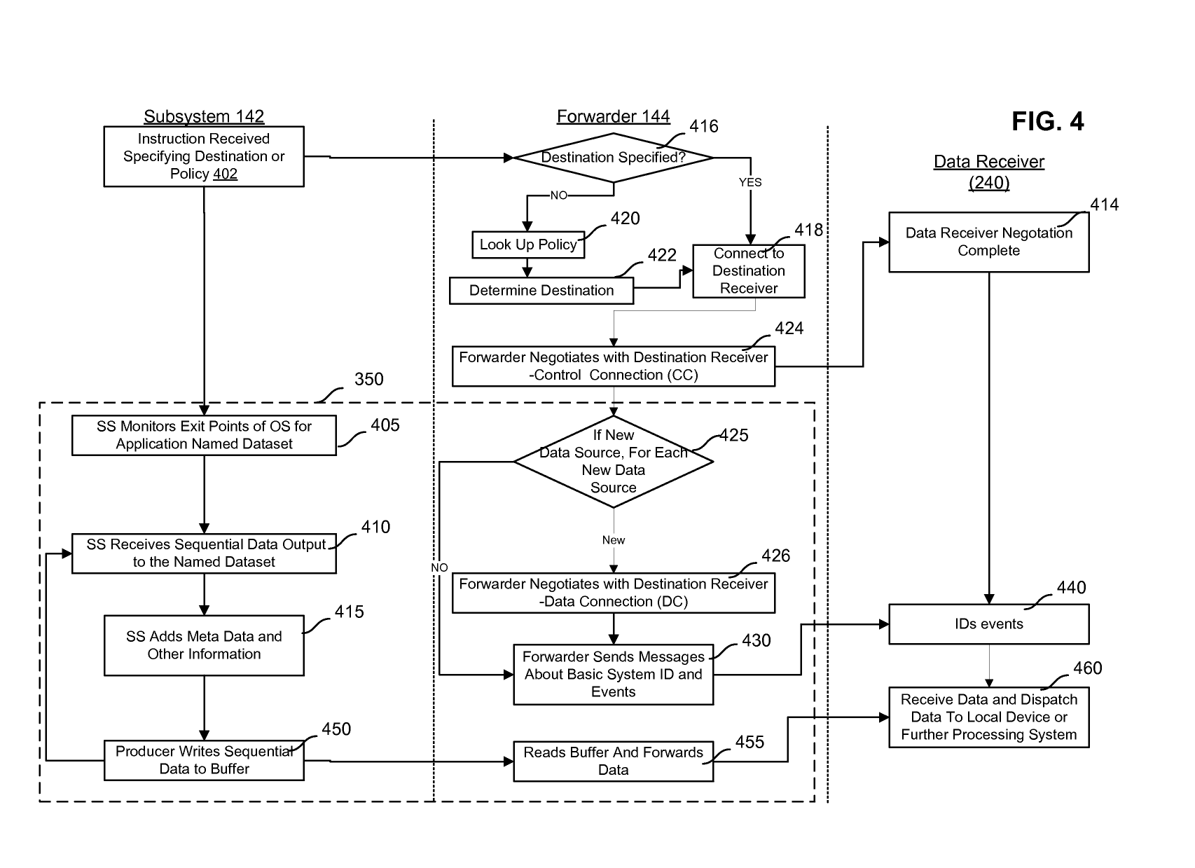

FIG. 4 illustrates various steps performed by different elements described herein in order to implement data transfer to off-platform devices, including a detailed implementation of step 350 in FIG. 3. FIG. 4 illustrates respective process steps of the subsystem 142 (steps 405, 410, 415, 450), forwarder 144 (steps 416, 418, 420, 422, 424, 425, 430, and 455) and a data receiver 240 (steps 414, 435, 440, 460). The data receiver will be referred to herein as data receiver 240, the steps illustrated with respect to data receiver 240 may be performed on any of the off-platform processing devices and any of the data receivers

In one embodiment, steps 405, 420, 415, 425, 426, 430, 450 and 455 represent one embodiment of performing step 350 of FIG. 3.

At step 402, an instruction is received defining the subsystem as the output for the named dataset as the application and including, for example, the type and ID for the data, as well as optionally the specific destination receiver address for the data (as discussed above).

At step 405, the privileged subsystem monitors data exit points of the operating system for data output to application named data sets which have been specified as being directed to the privileged subsystem. The application data outputs monitored are those for which a defined data set has been created in the subsystem.

At 410, the subsystem receives sequential data output by an application to the named data set. In the example set forth above, this can comprise an output of application 145 to the LOGFILE data set. At 415, the subsystem adds metadata, and other information, which may include the specific data receiver destination, to the sequential data output from an application 145. As illustrated below, this may be performed by adding data to data packets to be transmitted to the secondary, off-platform devices. Data received at 410 may be stored in a system memory address space buffer (i.e. buffer 155) while waiting for operations by the forwarder (device negotiation, appending data to the application sequential data output, etc.) to complete.

For any new data source, at 416, an initial determination is made as to whether the specific destination data receiver is specified in the instruction received at 402. If so, then the forwarder connects to the data receiver at 418 and begins the negotiation process at 424. If no specific destination receiver is specified in the instruction, the instruction may include, for example, other metadata including a TYPE and ID which may be used to determine the data receiver to which an application's output data will be drirected. Based on the type and ID (or in other embodiments any other piece of metadata), a policy lookup may be performed at 420 to determine eligible data receivers which are suitable to accept the data. A determination is then made at 422 as to the specific data receiver for the output data. The forwarder then connects to the destination data receiver at 418 and begins negotiation with the data receiver at 424.

On initialization for a given dataset, a forwarder may negotiate a control connection with one or more data receivers at 424. The negotiation occurs on the data receiver as well at 414 and the data receiver awaits data source transfers from the forwarder 144. The control connection is message oriented. Once the control connection is negotiated, basic system identification is sent to the data receiver. As new data sources arise, the forwarder uses the control connection to negotiate with the data receiver to establish a data connection.

For any data source, at 425 an initial determination is made at the forwarder as to whether the data source seen by the forwarder is a new data source and for each new data source, a data connection with the destination data receiver is established at 426. Once data source is up, the forwarder sends messages about basic system identification and data source identification. If the negotiation fails, the data will not be offloaded. If the data source is not new at 425, step 426, need not be repeated. The destination data receiver may be on an external processing device such as that illustrated at 244, 246 in FIG. 2. At 430, the forwarder uses the established data connection with the data receiver through a data connection to forward messages about basic system identification and subsystem and forwarder events to the data receiver.

On the external processing device, the data receiver 240 awaits any event and output data. Each data receiver may be connected to one or multiple data producers (application data sources), each producer providing output data from an application data source identified by a stream type and stream ID. Each data forwarder may output data to multiple data receivers. Each off-platform processing device may have one or more data receivers, each of which can be identified with an instruction as specified above.

At 440, the data receiver parses and reads IDs of events which include instructions defining how data received from a given data source should be processed. In another alternative, output data from the application via the subsystem may be provided to the data receiver in a native data format output as output by the application. The data receiver may then be configured to determine decoding the event from the native format into a usable interchange format, such as JavaScript object notation (JSON) which can then be used by a data processing application on the off-platform processing device.

As sequential data is received at 410, and the destination data and other information is sent to the forwarder at 415, the data producer (the application) writes sequential data to, the privileged subsystem and data buffer provided between the subsystem and the data forwarder. The forwarder then reads the buffer 155 and forwards the sequential data to the data receiver at 455. At 460, the data receiver receives data and dispenses the data to a local storage device, local processing device or application, or forwards the data to another processing system at 460. Receiver identifies delimited events, log messages or data records within the stream of data received over data connection at 460. In one example, the data receiver may dispatch the received data for concurrent decoding on a further processing system.

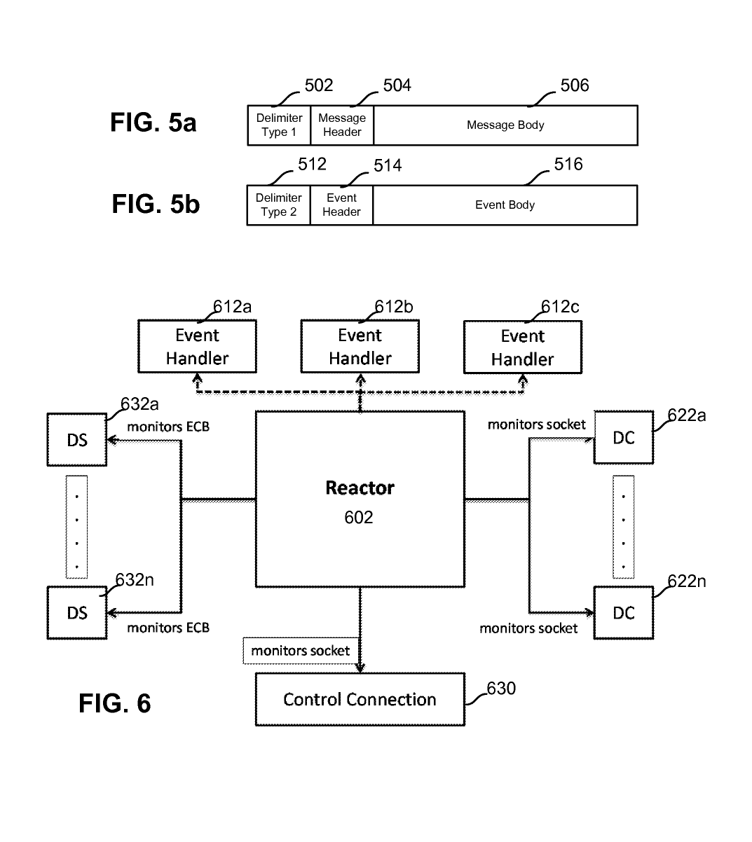

FIGS. 5A and 5B illustrate a control channel message and a data channel message output by the data forwarder on the control channel and data channel, respectively. In FIG. 5A, a control message includes a first delimiter type 502, a message header 504, and a message body 506. The message body 506 may specify the information about the basic forwarder system identification, the type of data to be received, and the destination for the data to be received at step 450. Header 504 may include a message code, a message identifier, and a message length. FIG. 5B, a data message includes a second delimiter type 512, an event header 514, and the event body 516. The event body 516 comprises the data to be provided to the data receiver. Header 514 may specify the event type and the event length.

In another alternative, data sources may have a fixed event type and fixed data length. A defined fixed length may be negotiated during the negotiation at 424. The data connection may then contain only the event delimiter and the body itself.

Each of the data and control message may be implemented using Google protocol buffers, which comprises a method of serializing structured data. Protocol buffer compilers are publically available. Alternatively, the messages may be implemented in XML. Data transfer may be encoded using standard UTF-8 protocol. In this implementation, fixed length encoding strings are utilized for convenience. In this alternative, when application data is read from data buffer 155, the forwarder is responsible for parsing the data into the fixed length encoding strings for use by the data receivers.

FIG. 6 illustrates a functional block diagram of the forwarder 144. Forwarder 600 may include a reactor 602, having a control connection socket 630, event handlers 612a, 612b, and 612c, data control sockets 622a-622n and data source ports 632a-632n, and control connection 630. In the above example, there may be any number of event handlers, sockets and ports. The forwarder 600 may be implemented using communication services provided by the operating system. In select operating systems, the UNIX system services may provide the ability to connect subsystems and applications to network devices by providing TCP/IP and SNA functions. The reactor of the forwarder may comprise a non-blocking socket input/output device which monitors data control sockets and data source sockets and event control blocks (ECBs) of the data buffer.

Each forwarder allocates a number of data buffers upon initialization of the forwarder or dynamically as the forwarder is executing. Each data buffer consists of data area and an ECB. When a subsystem registers data source with forwarder, the subsystem negotiates with the forwarder to establish a data connection for the data source. The forwarder takes a free (or allocates new) data buffer (including the data area and associated EBC), links it with data connection and transfers this information into reactor 602 for monitoring. Once all this is done, registration of the data source is successful and the forwarder instructs the subsystem of the data buffer that should be used to serialize the data source's data. When application passes data to subsystem, the subsystem will write to data area and then signal the ECB. This can be considered a “send” event by the forwarder.

The reactor 602 generally comprises a socket and ECB monitor which calls one or more event handlers 612a, 612b, and 612c when activity occurs on any one of the sockets. The event handler for a write to the buffer may define a further read and forward of the data in the buffer in real time—transmitting data to a defined data-receiver on an off-platform processing device as described herein. Reactor 602 monitors data buffer ECBs 632a . . . 632n, data connection sockets 622a . . . 622n and control connection socket 630 for events. Note that there is always link between data buffer and data connection. As events happen on data buffer ECBs 632a . . . 632n, data connection sockets 622a . . . 622n or control connection 630, the events and entities on which their occurred (data buffer, data connection or control connection) are dispatched to event handlers 612a, 612b, and 612c for processing. Event handlers 612a, 612b, and 612c then act on the event. For example, when a data buffer ECB is signaled, this is an indication that new data that should be forwarded to a data receiver. If the data connection socket linked with the buffer has send queue capacity, then the event handler will copy as much data as possible into data connection socket send queue. If the data connection socket does not have send queue capacity, then the handler will wait for DC socket to be ready to send event data. The reactor will process this event and trigger an event handler 612a-612c that will move as much data as possible from data buffer linked with the DC socket This design minimizes the forwarder's impact on the mainframe system.

A data receiver may be implemented as code configured to provide an actor system on the secondary, off-platform processing device (such as processing devices 242, 244, 246). In one implementation, a data receiver may be created on a Java based virtual machine platform such as that provided using the Akka toolkit from Typesafe, Inc., San Francisco, Calif. The data receiver identifies messages, events and records in TCP/IP streams, and decodes messages. The data receiver may be implemented as a finite state machine receiving data as a persistent datatype.

Multiple data receivers may be organized into operational pools under the control of a control server. Such organization in useful in, for example, parallel decoding of data utilizing pools of data receivers and decoding processes receiving data from a single data source. In such cases, incoming events may be marked with a sequence number which is passed with a decoded event. In such cases, events from a data server (a data source) may be provided to an event decoder actors and forwarded to a decoder system for further processing. Marking events with sequence numbers may be utilized where parallel event decoding occurs on multiple data receivers.

As noted above with respect to step 360, the data receiver may be monitored to determine whether any issues arise with the data receiver and if so, the data may be redirected to a different data receiver capable of processing the data based on a policy associated with the data.

FIG. 7 illustrates a high level block diagram of a computer system which can be used to implement processing device 102 (see FIG. 1). The computer system of FIG. 7 includes a processor unit 770 in communication with main memory 772. Processor unit 770 may contain a single microprocessor, or may contain a plurality of microprocessors for configuring the computer system as a multi-processor system. These one or more processors can perform the processes described above. Main memory 772 stores, in part, instructions and data for execution by processor unit 770. If the system described herein is wholly or partially implemented in software, main memory 772 can store the executable code when in operation. Main memory 772 may include banks of dynamic random access memory (DRAM) or flash memory, as well as high speed cache memory.

The system of FIG. 7 further includes a mass storage device 774, peripheral device(s) 776, user input device(s) 780, output devices 778, portable storage medium drive(s) 782, a graphics subsystem 784 and an output display 786. For purposes of simplicity, the components shown in FIG. 7 are depicted as being connected via a single bus 788. However, the components may be connected through one or more data transport means. For example, processor unit 770 and main memory 772 may be connected via a local microprocessor bus, and the mass storage device 774, peripheral device(s) 776, portable storage medium drive(s) 782, and graphics subsystem 784 may be connected via one or more input/output (I/O) buses. Mass storage device 774, which may be implemented with a magnetic disk drive or an optical disk drive, is a non-volatile storage device for storing data and instructions for use by processor unit 770. In one embodiment, mass storage device 774 stores the system software for implementing the technology described herein for purposes of loading to main memory 772. Peripheral device(s) 776 may include any type of computer support device, such as an input/output (I/O) interface, to add additional functionality to the computer system. For example, peripheral device(s) 776 may include a network interface for connecting the computer system to a network, a modem, a router, etc. User input device(s) 780 provides a portion of a user interface User input device(s) 780 may include an alpha-numeric keypad for inputting alpha-numeric and other information, or a pointing device, such as a mouse, a trackball, stylus, or cursor direction keys. In order to display textual and graphical information, the computer system of FIG. 7 includes graphics subsystem 784 and output display 786. Output display 786 may include a cathode ray tube (CRT) display, liquid crystal display (LCD), head mounter display, projector or other suitable display device. Graphics subsystem 784 receives textual and graphical information, and processes the information for output to display 786. Additionally, the system of FIG. 7 includes output devices 778. Examples of suitable output devices include speakers, printers, network interfaces, monitors, etc.

The components contained in the computer system of FIG. 7 are those typically found in computer systems suitable for use with the technology described herein, and are intended to represent a broad category of such computer components that are well known in the art. Thus, the computer system of FIG. 7 can be a personal computer, mobile computing device, smart phone, tablet, workstation, server, minicomputer, mainframe computer, or any other computing device. The computer can also include different bus configurations, networked platforms, multi-processor platforms, etc. Various operating systems can be used.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

A subsystem author or system operator may thus cause an operating system on a first processing system to create a privileged subsystem in the operating system. The author may cause creation of the privileged subsystem by distributing code configured to enable the creation of the privileged subsystem, while a system administrator or operator may cause creation of the privileged subsystem by executing such code. The privileged subsystem acquires sequential data output by a data producing application which is directed by the data producing application to a named dataset via the operating system responsive to an instruction to the operating system, the instruction specifies that the sequential data from the data producing application to the named dataset be processed by the privileged subsystem. A subsystem author or system operator may cause the first processing system to create a data forwarder by distributing code configured to enable the creation of the data forwarder. A system administrator or operator may cause creation of the data forwarder by executing such code. The data forwarder establishes communication with an external processing system, and acquires the sequential data from the privileged subsystem. The data forwarder transmits the sequential data to the external processing system based on an instruction which defines the external processing system as a destination for the sequential data.

The corresponding structures, material s, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
causing an operating system on a first processing system to create a privileged subsystem in the operating system, the privileged subsystem acquires sequential data output by a data producing application which is directed by the data producing application to a named dataset via the operating system responsive to an instruction to the operating system, the instruction specifies that the sequential data from the data producing application to the named dataset be processed by the privileged subsystem; and
causing the first processing system to create a data forwarder, the data forwarder establishes communication with an external processing system, the data forwarder acquires the sequential data from the privileged subsystem, the data forwarder transmits the sequential data to the external processing system based on the instruction, the instruction defines the external processing system as a destination for the sequential data.

2. The method of claim 1 further including causing reservation of a system memory address space in the first processing system, the privileged subsystem and the data forwarder operate in the system memory address space.

3. The method of claim 2 further including causing creation of a data buffer in the system memory address space, the data buffer stores the sequential data acquired by the privileged subsystem, the data forwarder reads the sequential data from the data buffer in a sequence the sequential data is written to the data buffer.

4. The method of claim 1 further including causing the external processing system to create an external system receiver, the external system receiver communicates with the data forwarder via a network to receive the sequential data at the external processing system.

5. The method of claim 4 further including causing the data forwarder to create a control channel and a data channel to the external system receiver over the network, the control channel carries messages from the data forwarder specifying a destination on the external processing system for the sequential data.

6. The method of claim 1 wherein the operating system receives the instruction specifies metadata associated with the sequential data, at least a portion of the metadata identifies an operation on the data by the external processing system, the data forwarder determines the external processing system based on a policy associated with the metadata.

7. The method of claim 1 wherein the instruction comprises a JCL DD statement specifying operations to the named dataset be processed by the privileged subsystem, and further specifies a specific address of the external processing system.

8. The method of claim 1 wherein the instruction comprises a dynamic allocation of the named dataset to processing by the privileged subsystem.

9. A computer program product, comprising:
a computer readable storage medium having computer readable program code embodied therewith, the computer readable program code comprising:
computer readable program code configured to create a privileged subsystem in a processing system having other subsystems accessible to applications on the processing system, the privileged subsystem configured to receive sequential data output from an application which is directed by the application to a named dataset addressed by the application and stored on a memory device in the processing system; and
computer readable program code configured to create a data forwarder, the data forwarder adapted to communicate with an external processing system, the data forwarder adapted to transmit the sequential data acquired by the privileged subsystem to the external processing system; and
wherein the computer readable program code configured to create the privileged subsystem and the data forwarder respond to an instruction to an operating system, the instruction specifies output requests by the application to the named dataset be processed by the privileged subsystem, the instruction specifying the external processing system as a destination for the sequential data to the data forwarder.

10. The computer program product of claim 9 wherein the computer readable program code configured to create a privileged subsystem reserves a system memory address space, the subsystem and the data forwarder operate in the system memory address space.

11. The computer program product of claim 9 wherein the computer readable program code configured to create a privileged subsystem creates a data buffer, the privileged subsystem writes the sequential data to the data buffer, the data forwarder reads the sequential data from the data buffer.

12. The computer program product of claim 9 wherein the computer readable program code configured to create a privileged subsystem includes code configured to call a subsystem interface of the operating system to monitor at least one exit point of the operating system for function calls by the application and recognize I/O function calls by the application, the privileged subsystem responds to the function calls to accept the sequential data.

13. The computer program product of claim 9 further including computer readable program code configured to create a receiver at the external processing system, the receiver configured to communicate with the data forwarder via a network to provide the sequential data to a destination on the external processing system.

14. The computer program product of claim 9 wherein the instruction comprises a dynamic allocation of the named dataset specifying I/O operations to the named dataset be processed by the privileged subsystem.

15. The computer program product of claim 9 wherein the instruction comprises a JCL DD statement specifying I/O operations to the named dataset be processed by the privileged subsystem.

16. A computing apparatus, comprising:
a processor and a memory, the processor configured to access the memory to execute instructions;
a storage device, the storage device includes:
code stored in the storage device configured to create a pseudo device recognized by an operating system, the pseudo device addressable by the operating system to receive sequential data from an application, the application configured to write the sequential data to a named dataset addressed in the application, the operating system directs the sequential data addressed to the named dataset by the application to the pseudo device; and
code stored in the storage device configured to create a data forwarder, the data forwarder adapted to communicate with an external processing system, the data forwarder adapted to transmit the sequential data acquired by the pseudo device to the external processing system; and
wherein operating system, the pseudo device and the data forwarder respond to an instruction to the operating system, the instruction specifying output requests by the application to the named dataset be directed to the pseudo device, the instruction specifying the external processing system as a destination for the sequential data to the data forwarder.

17. The computing apparatus of claim 16 wherein the code configured to create a pseudo device is configured to create a pseudo device as a privileged subsystem of the operating system, the privileged subsystem recognizes I/O function calls by the application to the operating system, the privileged subsystem responding to the I/O function calls to accept the sequential data.

18. The computing apparatus of claim 17 wherein the code configured to create a pseudo device is configured to create the pseudo device in a reserved system memory space, the reserved system memory space includes a data buffer, and the sequential data is held in the data buffer.

19. The computing apparatus of claim 18 wherein the code configured to create a pseudo device is configured to create a pseudo device which interacts with a subsystem interface of the operating system to monitor exit points of the operating system for the I/O function calls by the application.

20. The computing apparatus of claim 16 wherein the instruction comprises a JCL DD statement specifying I/O operations to the named dataset be directed to the pseudo device, and further specifies metadata associated with the sequential data, at least a portion of the metadata instructs an operation on the sequential data by the external processing system.
